(19) United States
(12) Patent Application Publication
(10) Pub. No.: US 2011/0177250 A1
(43) Pub. Date: Jul. 21, 2011

(54) APPARATUS AND METHOD FOR MASKING A COMPONENT ZONE

(75) Inventors: Andreas Jakimov, Muenchen (DE); Manuel Hertter, Muenchen (DE); Stefan Schneiderbanger, Lauterbach (DE)

(73) Assignee: MTU Aero Engines GmbH

(21) Appl. No.: 13/119,801

(22) PCT Filed: Aug. 11, 2009
(86) PCT No.: PCT/DE09/01143

§ 371 Date: Mar. 18, 2011

(30) Foreign Application Priority Data
Sep. 20, 2008 (DE) 10 2008 048 127.0

(51) Int. Cl. B05D 3/12; B05C 11/00

(52) U.S. Cl. 427/300; 118/504

(57) ABSTRACT

An apparatus and a method for masking a component zone which is to be omitted by the spray jet during the thermal spraying of a component is disclosed. The apparatus can be elastically deformed at least partially at room temperature for attachment to the component. During the thermal spraying operation the apparatus has at least one inelastic region such that the impinging spray particles adhere to the surface thereof. After the thermal spraying operation, the apparatus can be removed from the covered component zone without leaving any residue. In this way, a simple, reusable solution is created, which avoids the disadvantages of the prior art.

### BACKGROUND AND SUMMARY OF THE INVENTION

This application claims the priority of International Application No. PCT/DE2009/001143, filed Aug. 11, 2009, and German Patent Document No. 10 2008 048 127.0, filed Sep. 20, 2008, the disclosures of which are expressly incorporated by reference herein.

The present invention relates to an apparatus for masking a component zone of a component, which is coated with a thermal spray coating. The present invention relates in particular to the masking and the partial coating of components that are produced and used in the aviation and aerospace industry such as, for example, gas turbines or aircraft engines. The invention further relates to a method that the aforementioned apparatus uses for masking and partially coating component surfaces by means of thermal spraying, in particular, components that are produced and used in the aviation and aerospace industry such as, for example, gas turbines or aircraft engines.

Thermal spraying is a coating method in which a spray additive is continually melted and projected onto a surface to be coated. Because of the accumulation of flatten and lamellar droplets, layers develop on the surface to be coated, which form the so-called spray coating, which may be harder, more brittle and more porous than the starting material. Various spray methods are included under the term “thermal spraying” which differ in terms of the type of spray additive material, fabrication or energy transfer medium such as, for example, electric arc spraying, laser spraying, flame spraying, high-speed flame spraying or plasma spraying in a vacuum or in a controlled atmosphere. The characterizing properties such as, for example, porosity, structural constitution, density, phase composition, hardness, modulus of elasticity and the internal stress of the layers that are generated by this method, are a function of many parameters, among others, thermal energy, the powder material used, kinetic energy, type of process gases, substrate material to be coated and the pretreatment of same.

The advantages of the thermal spraying, on the one hand, are that every material can be both sprayed as well as sprayed on, that with few exceptions the materials to be coated are also not thermally altered and, above all, that almost every component size and every component geometry may be coated. In addition, this method permits good reproducibility, high quality standards and excellent automation of the coating process to be achieved. Finally, several elements may be contained or combined in the spray coatings so that the thermal spraying is characterized by a very flexible use.

For these reasons, thermal spray methods are very important both in the fabrication and design of new parts as well as in the repair of high-quality worn parts. As a result, the fields of use and applications of the thermal spraying are diverse and range from decorative coatings for household appliances and kitchen equipment to fail-safe protective coatings and wear protective coatings in the automotive industry to abradable coatings, high-temperature protective coatings and dimensional correction coatings in the aviation and aerospace industry.

However, it is frequently necessary for specific partial areas to remain uncoated during the thermal spraying process. Techniques were developed for this that protect the corresponding component zones from the spray jet. To this end, usually after a specific surface treatment, the corresponding component zones that are to be protected are provided with coverings, which serve to define layer surfaces and regions that are supposed to be skipped by the spray jet.

Various techniques for covering these regions that are not to be coated are known from the prior art.

For one, overlay masks made of various non-elastic materials are considered such as those disclosed in Japanese Patent Document No. JP 3158451, for example. In this document the overlap mask is made of a multilayer cover foil, which is composed of a metallic and a resin film and which is applied to parts on large areas that are to be coated. These types of overlap masks are not suitable for surfaces that are more complicated to protect without additional adaptation to the shape and fastening possibilities, and cannot be reused as a rule.

Furthermore, a mask is known from U.S. Pat. No. 6,645,299, which is made of a thin steel sheet, which is contoured to the shape of the component to be protected and fastened to the material to be protected with a clamping mechanism. The disadvantage of these types of masks is that there must be matching receptacle devices for fastening to the component and that it is not possible to rule out damage to the component before and after the spraying process caused by fastening and removing the mask. In addition, reusability of the mask is limited due to material accumulations on the mask during the spraying process. Furthermore, with reuse there is the risk that particles that are already present may detach from the mask surface during the further spraying process. These types of contamination have a negative impact on the quality of the adjacent spray coatings and, above all, reduce the reproducibility of the coating process.

Other overlap masks from the prior art are produced from metals and their alloys, such as the mask known from Japanese Patent Document No. JP 6010111, and they are either applied directly to the surface to be protected or adapted true to the contour of the component and provided with spacing zones that prevent the spray coating from adhering to the mask, and at the same time protect the regions that are not to be sprayed from the spray jet. The construction and structure of these types of covering devices require corresponding lead times and are worthwhile only starting with high unit numbers. In addition, the masks must be laboriously cleaned after several spraying operations.

Another simple possibility is using not-to-be-coated parts with adhesive masks made of adhesive tape or the like that is affixed directly to the parts that are not to be coated. Such a covering technique is known from the prior art. U.S. Pat. No. 5,203,944 discloses, for example, the use of several masks for fabricating a three-dimensional structure, which masks are made of a plastic film, which, on the one hand, has a removable substrate and, on the other hand, an adhesive surface. One disadvantage, however, is that the material for the adhesive tape and adhesives is impacted negatively at higher temperatures. In addition, it is known that masks made of adhesive tape or reinforced adhesive tape can be frequently and quickly destroyed in the course of the spraying process. As a result, they have to be removed and replaced on a frequent basis. In addition, the adhesive residue left behind by the adhesive tape or the like on the protected component surfaces must be eliminated by means of laborious cleaning processes of a mechanical or chemical nature. This surface post-treatment that is required is associated with great technical effort and a lot of time and consequently with increased costs. Besides, the chemicals used for the cleaning process are detrimental to the environment as a rule, and the risk of damaging the surfaces with a mechanical process is very high.

Another covering possibility known from the prior art provides for a masking of a lacquer or a mixture containing a binding agent to be applied to the to-be-protected regions, such as described in U.S. Pat. No. 4,464,430. In this case as well, after the thermal spraying process, the very adherent coating material must be removed from the masking or the masking itself must be removed. Solvents are used most of the time to do this and these solvents are associated with involved disposal measures and must be disposed of as hazardous waste along with other waste that is produced.

Furthermore, U.S. Pat. No. 6,060,117 is known from the prior art, which discloses a heat-resistant mask, which is made of an organic thermosetting plastic layer that is coated with a hard protective layer to which the particles from the spray jet cannot adhere. The disadvantages of this mask are that it is expensive to produce and it has a negative effect on the adjacent spray coating from the impact behavior of the spray particles and it causes a reduction in its quality because of the incorporation of unmolten particles with poor cohesion. In addition, the disclosed mask must be used along with a mounting.

Still other masking techniques are known from the prior art, which have been developed for special applications. For example, a covering made of a silicone rubber is known from U.S. Pat. No. 5,691,018, which is used to protect a portion of a spray device. However, in this case no component zones are covered and the silicone rubber has an unfavorable reflection behavior of the spray particles impinging thereon because of the elastic surface. Finally, European Patent Document No. EP 0776704B1 and U.S. Pat. No. 5,573,814 disclose a masking of cylinder bore during thermal spraying, which is made of an inflatable and collapsible air-tight bag made of heat-resistant cloth, which is coated on opposite sides with a sacrificial layer of heat-resistant non-stick material. These collapsible, air-tight bags deploy their protective effect in an inflated state during the spraying process and are operated by a regulating and inflating device that was developed especially for this purpose.

Conventional masks are thus subject during the thermal spraying either to a high level of adhesion of the coating material and are therefore dimensionally stable only for a limited time or they have a surface to which no coating material can adhere. In the first case, most of the time it is possible to clean the used masks after thermal spraying, but this is very time consuming and costly. In the second case, the unfavorable impacting of the spray particles on the mask surface produces undesired deterioration of the coating quality on the surfaces adjacent to the mask.

The object of the present invention is therefore to create an apparatus and a method for masking components that are to be thermally sprayed, in particular components for the aviation and aerospace industry, such as, for example, for gas turbines or aircraft engines, which avoid the cited disadvantages of the prior art. Furthermore, a solution is supposed to be provided which makes reliable, quick, clean, reproducible and cost-effective partial coating of components possible.

This object is attained by a mask for masking components as well as a method.

The apparatus according to the invention for masking components to be thermally sprayed is made at least partially of a material that can be elastically deformed at room temperature and is produced with slightly smaller dimensions in a shape matching the partial regions of the component that are to be protected. The elastic deformation of the apparatus that is at least partially possible at room temperature guarantees that the apparatus can be attached to corresponding components that are to be protected from the spray jet in a manner that is simple, close-fitting and protects the material. Because of the at least partial elasticity and the slightly smaller dimensions of the apparatus, no fastening devices are required either on the component, or on the apparatus itself to keep the apparatus in the foreseen spot. In addition, the apparatus according to the invention for masking components to be sprayed during the spraying process has at least one inelastic region to which the impinging spray particles remain adhered to the surface of the apparatus and are thereby prevented from reaching the spray coatings. This prevents an undesired deterioration of the quality of the spray surface adjacent to the apparatus. After the spraying process, the apparatus can ultimately be removed via elastic deformation from the component surfaces to be protected simply, quickly and without leaving any residue. The risk of damaging the component surface in the process is prevented by the simple attachment of the apparatus to the component and by the absence of a surface treatment of the protected component zones after the thermal spraying process.

In an advantageous exemplary embodiment of the invention, the apparatus is removed non-destructively from the component being protected after at least one thermal spraying process and is used again in a new thermal spraying process. For example, one could imagine an apparatus made partially of one the materials listed below and of a non-elastic part, for example made of one or several metal surfaces that are held together and form the apparatus for masking.

In another advantageous embodiment of the invention, the apparatus material is made of at least one of the following materials: silicone resin, thermally cross-linkable elastomers, thermosetting plastics, thermoplastics, natural rubber with additives, silicone elastomers, polyamide (PA), polycarbonate (PC), polymethyl methacrylate (PMMA), polyoxymethylene (POM), polytetrafluorethylene (PTFE), silicone polymers, vinyl silicone polymers, polyester, epoxy resin, quartz/silica, dimethylvinyl, xylenes, polyether, polyethylene, polyvinyl chloride (PVC), polystyrene (PS), polypropylene (PP), polysulfides, ethylene propylene rubber. For example, silicone elastomers can be created simply with corresponding smaller dimensions on a positive mold and be used in the manner according to the invention by selecting a different impact surface material.

It is preferred that a plastic be used that is elastic at lower temperatures and hardens at a higher temperature around 80° C. as is the case during the thermal spraying. Therefore, attaching and removing the masking is easy, but because of the hardening during the spraying process, it becomes inelastic in such a way that ricocheting of the impinging spray particles does not occur. Furthermore, it is especially preferred that a reversible plastic be used that features the above-mentioned properties, but that becomes elastic again at a lower temperature, i.e., after cooling. This simplifies the removal and reuse of the masking and also makes it easier to clean the apparatus.

In another advantageous embodiment of the invention, the apparatus is at least partially reinforced with metallic fibers, glass fibers or plastic fibers. For example, one can imagine an apparatus in which metallic fibers placed parallel to one another reinforce the stability of the apparatus in this direction, but the elasticity perpendicular to this direction is preserved. A cylindrical apparatus for masking a portion of a cylinder with embedded and non-elastic fibers along its longitudinal axis would need to be attached to this cylinder through radial elastic deformation, for example.

In a further embodiment of the invention, at least one portion of the surface of the apparatus for masking is provided with an additional protective layer which promotes the adhesion of the spray particles during the thermal spraying process and which can be dissolved from the surface of the apparatus after the spraying process by a suitable mechanical and/or chemical cleaning method. This additional layer is made for example of a solvent-sensitive lacquer, a water-receptive layer, a dried emulsion that is sprayed on beforehand, which is able to be dissolved with either water or a solvent.

A method according to the invention for masking components to be thermally sprayed provides an apparatus that is at least partially elastic at room temperature, which has smaller dimensions in relation to the component to be protected in order to improve the quality of the spray coatings adjacent to the masking and to guarantee a reproducible production process. Elastic deformation is used to attach the corresponding apparatus to the corresponding component and, because of the elastic properties and smaller dimensions of the apparatus, it is held tightly adjacent in this position during the spraying process. This is especially advantageous for geometrically complicated components such as turbine blades that have convex and concave profile cambering and twisting over the length of the blade for instance. Upon termination of the coating process and after the both the apparatus and the component have cooled down again, the apparatus is removed from the component surface to be protected via elastic deformation quickly, simply, and without leaving any residue.

In a further embodiment of the method, the apparatus is cleaned of the spray coating on it in a cleaning process upon termination of the thermal spraying process and subsequent cooling and removal from the sprayed component. One cleaning method involves deforming the apparatus elastically in such a way that the spray coating flakes off its surface. Another cleaning method involves, for example, holding the to-be-cleaned apparatus in a water or solvent bath whose temperature is varied. A further cleaning method provides for using ultrasound to support the cleaning procedure.

An apparatus or a method as described above is used in particular for producing, repairing and coating components of gas turbines or aircraft engines. Particularly in the case of the blading of gas turbines, convex and concave profile cambering, twisting and merging radii pose particularly great difficulties when attaching suitable masks. These difficulties can be overcome by an apparatus according to the invention for masking component zones and a corresponding method.

Additional measures improving the invention are described in greater detail on the basis of the figures in the following together with description of a preferred exemplary embodiment of the invention.

### BRIEF DESCRIPTION OF THE DRAWINGS

FIG. 1 is a schematic representation of a component to be partially coated that has an apparatus according to the invention for masking a component zone attached to the lower portion thereof; and

FIG. 2 is a schematic individual representation of the apparatus from FIG. 1 before being attached to the component.

### DETAILED DESCRIPTION OF THE DRAWINGS

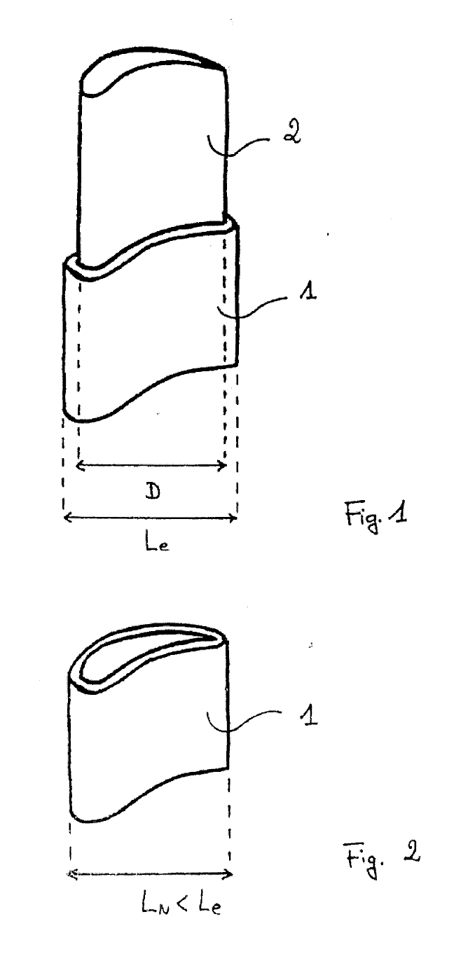

FIG. 1 shows a schematic representation of a component 2 to be partially coated by means of thermal spraying that has an apparatus 1 according to the invention for covering the lower component zone attached to the lower portion thereof. The component 2 is the blade of a rotor of a gas turbine, wherein only the blade pan 2 is depicted. FIG. 1 also indicates the length of the blade pan D and the length of the attached apparatus Lₑ for masking a component zone. Particularly high mechanical stress to the component occurs in the upper area of the blade pan. As a result, in the depicted exemplary embodiment, the upper portion of the blade is coated with a thermally sprayed anti-wear coating made of chromium carbide nickel aluminum. The arrangement that is formed by the apparatus and the blade is covered from its reverse side by the spray jet and thereby provided with a spray coating having an appropriate layer thickness. In the depicted exemplary embodiment, the apparatus 1 for masking the lower part of the blade 2 is made completely of polyamide and its height corresponds to half the height of the blade.

FIG. 2 shows a schematic representation of an apparatus 1 according to the invention for masking a component zone prior to its attachment to the blade 2. FIG. 2 also includes the length L_{N} of the elastic apparatus that has not yet been attached. The shape of the apparatus 1 corresponds to the shape of the blade pan 2, wherein the apparatus 1 is embodied to be hollow over its entire height. The shape of the opening also corresponds to that of the blade pan 2, wherein the apparatus 1 is provided with smaller dimensions so that L_{N}<Lₑ applies and therefore the opening also has smaller dimensions than the blade pan 2. Additional embodiments of the apparatus 1 may be provided, which have a different progression of the boundary area between the regions that are to be coated and the regions that are not to be coated.

The invention is not restricted in terms of its design to the preferred exemplary embodiment indicated in the foregoing. In fact, a number of variants are conceivable that make use of the solution claimed in the patent claims even with different types of embodiments.

1.-13. (canceled)

14. An apparatus for masking a component zone during a thermal spraying process of a component, comprising:
a mask;
wherein the mask is elastically deformable at least partially at room temperature;
wherein at an elevated temperature during the thermal spraying process, the mask has at least one inelastic region that retains impinging spray particles on its surface via adhesion;
and wherein, at room temperature after the thermal spraying process, the mask is elastically deformable at least partially and is removable from a covered component zone of the component without leaving any residue.

15. The apparatus according to claim 14, wherein the mask is reusable for multiple thermal spraying processes.

16. The apparatus according to claim 14, wherein the mask is constructed of at least one of the following materials: silicone resin, thermally cross-linkable elastomers, thermosetting plastics, amorphous and partial crystalline thermoplastics, natural rubber with additives, silicone elastomers, polyamide (PA), polycarbonate (PC), polymethyl methacrylate (PMMA), polyoxymethylene (POM), polytetrafluorethylene (PTFE), silicone polymers, vinyl silicone polymers, polyester, epoxy resin, quartz/silica, dimethylvinyl, xylenes, polyether, polyethylene, polyvinyl chloride (PVC), polystyrene (PS), polypropylene (PP), polysulfides, ethylene propylene rubber.

17. The apparatus according claim 14, wherein the mask is constructed of at least one reversible plastic which becomes elastic again after cooling.

18. The apparatus according to claim 16, wherein the mask is reinforced with metallic fibers, glass fibers or plastic fibers.

19. The apparatus according to claim 14, wherein at least one portion of a surface of the mask has a protective layer.

20. The apparatus according to claim 19, wherein the protective layer is made of a solvent-sensitive lacquer, a water-receptive material or a dried sprayable emulsion.

21. A method for masking a component zone during thermal spraying of a component, comprising the steps of:
providing a mask that is at least partially elastic at room temperature, wherein the mask has smaller dimensions in relation to the component;
attaching the mask to the component zone of the component at room temperature by elastically deforming the mask;
hardening at least a portion of the mask via elevated temperature during the thermal spraying;
cooling the component and the mask; and
removing the mask from the component zone at room temperature by elastically deforming the mask without leaving any residue.

22. The method according to claim 21, further comprising a step of cleaning the mask after it is removed from the component zone.

23. The method according to claim 21, wherein the step of cleaning includes cleaning in a water or solvent bath.

24. The method according to claim 23, further comprising the step of varing a temperature of the water or the solvent bath.

25. The method according to claim 23, further comprising the step of treating the mask in an ultrasonic bath.

26. The method of claim 21, wherein the component is a component of a gas turbine or an aircraft engine.
